(19) United States
(12) Patent Application Publication
(10) Pub. No.: US 2008/0014390 A1
(43) Pub. Date: Jan. 17, 2008

(54) Multi-layer Thermoformed Fuel Tank and Method of Manufacturing the Same

(76) Inventors: Craig S. Scott, Oakdale, MN (US); Mark O'Hanlon, Novi, MN (US)

Correspondence Address: BLACKWELL SANDERS LLP, 4801 Main Street, Suite 1000, KANSAS CITY, MO, 64112, US

(21) Appl. No.: 11/427,815

(22) Filed: Jun. 30, 2006

(51) Int. Cl. B32B 27/08

(52) U.S. Cl. 428/35.7

(57) ABSTRACT

A motor vehicle fuel tank and a method of making a motor vehicle fuel tank is provided. In particular, a twin sheet thermoformed plastic fuel tank or other plastic container including a hollow plastic tank body having a first shell portion and a second shell portion is fused together to form a seam. A pair of thermoplastic sheets are vacuum-formed at an elevated forming temperature in upper and lower mold cavities of a molding apparatus to the shape of upper and lower shells. The mold cavities are closed together to form the hollow tank body by fusion bonding the upper and lower shells at respective attachment flanges on each. A method of automated, manual or combination automated/manual manufacture of the fuel tank of the present invention is also provided.

### BACKGROUND OF THE INVENTION

This invention relates generally to a motor vehicle fuel tank and a method of making a motor vehicle fuel tank. In particular, the present invention relates to fuel tanks for off-road motor vehicles such as all-terrain vehicles and snowmobiles and an automated or combination automated/manual manufacturing method of making multi-layer thermoformed plastic containers such as fuel tanks.

Plastic fuel tanks for motor vehicles have traditionally been manufactured by “blow molding” processes and, more recently, by a process commonly called “twin sheet thermoforming.” In blow molding, amass of liquid plastic at elevated temperature is expanded in a mold by injecting gas under pressure into the plastic mass. In conventional twin sheet forming methods, first and second sheets of thermoplastic material are heated and thermoformed using first and second thermoforming tools, such as vacuum molds, positioned opposite one another. Before the sheet surfaces facing away from the tools have cooled, the tools are moved together or closed so that the hot surfaces of the sheets fuse together proximate the edges or in any other area that protrudes and contacts the opposing sheet. The residual heat and soft surface of the thermoplastic materials allows the sheets to fuse together.

Articles that have traditionally been made of metal or wood can now be produced from thermoplastic materials. Forming automotive fuel tanks, for example, from thermoplastic materials provides a number of advantages. The fuel tank can be made in virtually any shape to fit in any available space within the automobile, thereby maximizing the use of space. Using the thermoplastic material, the automotive fuel tank can be made leak proof and more flexible thereby preventing the fuel tank from rupturing. Using thermoplastics and thermoforming techniques is also advantageous for other hollow or partially hollow articles.

### SUMMARY OF THE INVENTION

The present invention is directed to a motor vehicle fuel tank and a method of making a motor vehicle fuel tank. In particular, the present invention is directed to a twin sheet thermoformed plastic fuel tank or other plastic container including a hollow plastic tank body having a first shell portion and a second shell portion fused together to form a seam. A pair of thermoplastic sheets are vacuum formed at an elevated forming temperature in upper and lower mold cavities of a molding apparatus to the shape of upper and lower shells. The mold cavities are closed together to form the hollow tank body by fusion bonding the upper and lower shells at respective attachment flanges on each. A method of automated or combination automated/manual manufacture of the fuel tank of the present invention is also provided.

### BRIEF DESCRIPTION OF THE SEVERAL VIEWS OF THE DRAWING

In the accompanying drawings that form a part of the specification and that are to be read in conjunction therewith and in which like reference numerals are used to indicate like parts in the various views:

FIG. 1 is a top plan view of the fuel tank in accordance with one embodiment of the present invention;

FIG. 2 is a bottom perspective view of the fuel tank in accordance with one embodiment of the present invention;

FIG. 3a is a side perspective sectional view of the fuel tank in accordance with one embodiment of the present invention;

FIG. 3b is a top perspective sectional view of the fuel tank in accordance with one embodiment of the present invention;

FIG. 4 is a cross-section of the thermoplastic sheet in accordance with one embodiment of the present invention;

FIG. 5 is a schematic illustration of the twin sheet parallel processing system in accordance with one embodiment of the present invention;

FIG. 6 is a schematic illustration of the thermoforming stage in accordance with one embodiment of the present invention; and

FIG. 7 is a schematic illustration of the view of the method of making the plastic container in accordance with one embodiment of the present invention.

### DETAILED DESCRIPTION OF THE INVENTION

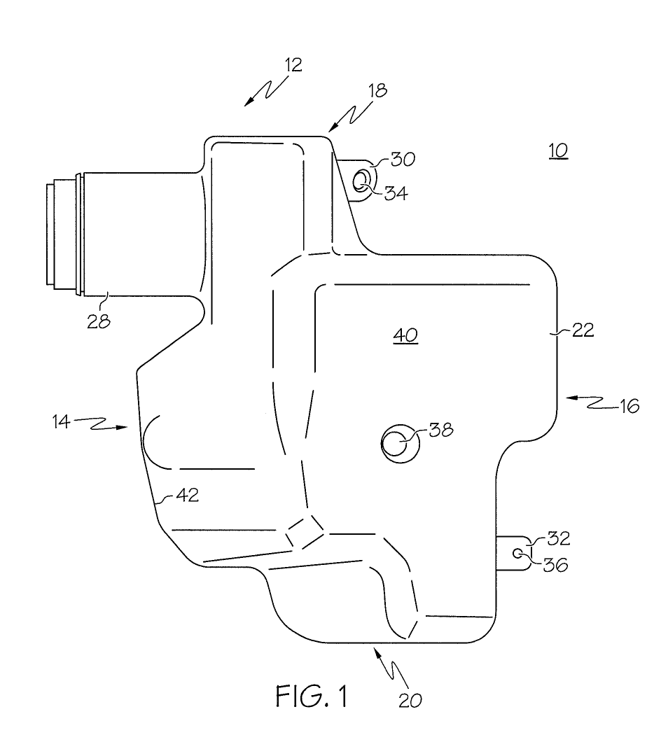

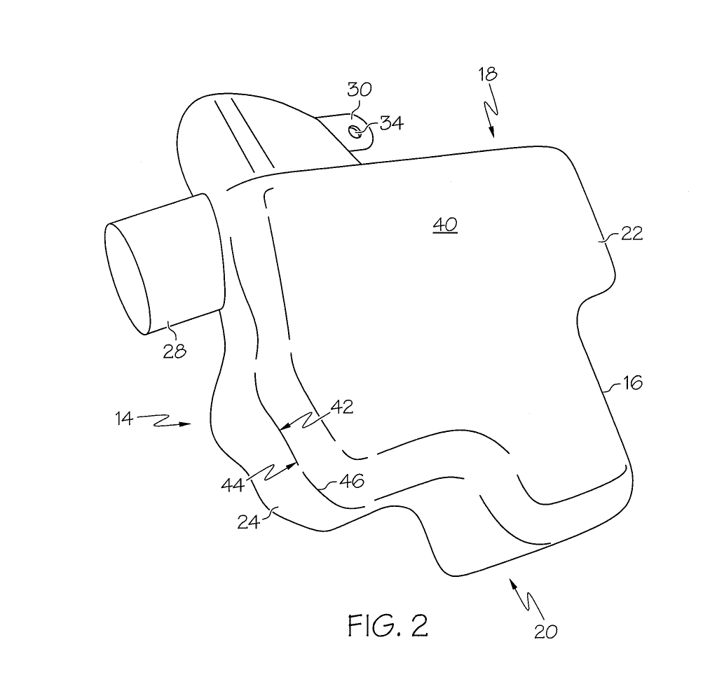

A fuel tank 10 embodying various features of the invention is shown in the drawings. As shown in FIGS. 1 and 2, fuel tank 10 includes a generally hollow fuel tank body 12 having a first side 14, an opposed second side 16, a first end 18, an opposed second end 20, a first shell portion 22, and a second shell portion 24 defining an interior 26. In one embodiment, a generally cylindrical fuel inlet 28 is disposed on first side 14 adjacent first end 18 and is in fluidic communication with interior 26 for filling and re-filling fuel tank body 12. It will be appreciated by those skilled in the art that inlet 28 may be selectively disposed on any portion of fuel tank body 12, such as adjacent second end 20 or on second side 16, according to the needs and design of the motor vehicle (not shown) within which fuel tank body 12 is placed.

A first securement means 30 in the form of a tab or flange is disposed on second side 16 adjacent first end 18 and a second securement means 32 in the form of a tab or flange is disposed on second side 16 adjacent second end 20. First and second securement means 30 and 32 define a first and second aperture 34 and 36, respectively, therethrough for the insertion of fastening means (not shown) in order to secure or affix fuel tank body 12 to the motor vehicle. In one embodiment of the present invention, an outlet 38 disposed in any suitable location on fuel tank body 12, such as on a top surface 40 of first shell portion 22 as shown in FIG. 1, for draining or emptying fuel tank body 12 as desired or to act as a vent hole.

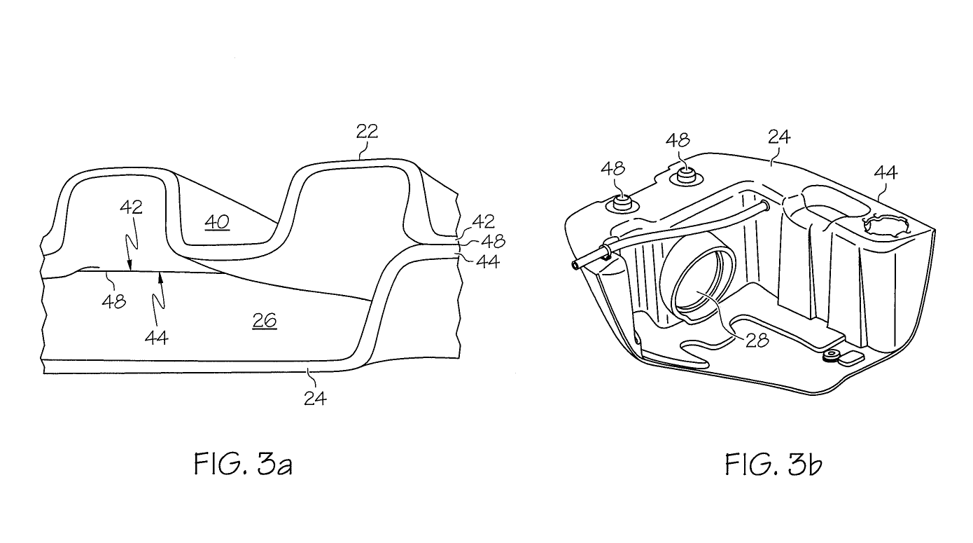

First shell portion 22 is formed of a thermoformed multi-layer sheet and includes a first edge 42 defining the perimeter of first shell portion 22. Second shell portion 24 is also formed of a thermoformed multi-layer sheet and includes a second edge 44 defining the perimeter of second shell portion 24. Edges 42 and 44 meet to define a seam or flange 46, as shown in FIG. 3a, that may be heated or fused together to form a seal. Turning to FIG. 3b, a first part of optional shell portion coupling means 48 for coupling edges 42 and 44 are provided.

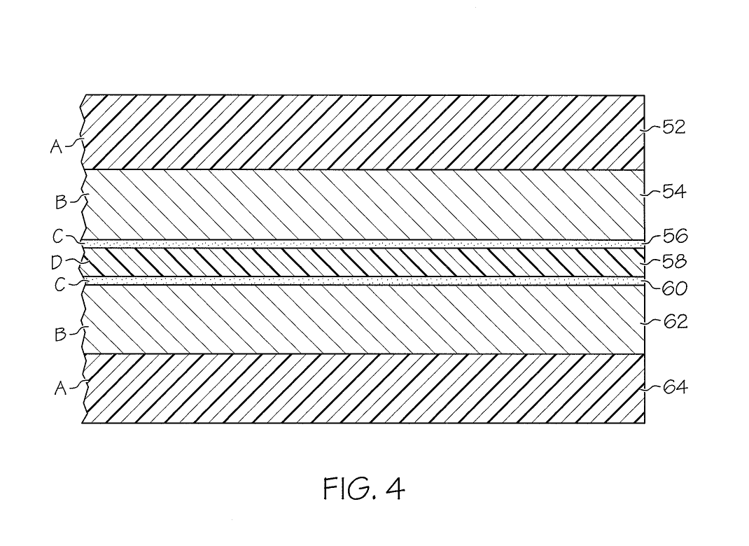

Turning now to FIG. 4, a cross-sectional view of the multi-layer structure of one of shell portions 22 or 24 is shown. A first layer 52 and a seventh layer 64 each comprises from about 10-25% by volume [change based on other claims] of the multi-layer sheet and is formed of a composition A. The preferred composition A includes of from about 0.5-100% by weight, more preferably from about 50-99% by weight, more preferably from about 70-99% by weight, and most preferably from about 90-99%, of at least one polyolefin polymer. Preferred polyolefin polymers include polyethylene, polypropylene, polybutene, polyisoprene, copolymers thereof, terpolymers thereof, and mixtures thereof. Particularly preferred is high density polyethylene (HDPE). The preferred composition A also includes at least one colorant. From about 0-49% by weight, more preferably from about 0.1-10%, most preferably 0.1-5%, and any other range contained therein, of colorants may be added. A color concentrate may be added to the layer to yield a colored layer, an opaque layer, or a translucent layer. Preferred color concentrates include color formulations including black, white, red, blue, yellow, green, orange and other colors suitable for thermoformed articles. It will be appreciated by those skilled in the art that other additives may be added to first layer and/or seventh layer 64 or to one or more other layers of the film of the present invention in order to improve certain characteristics of the particular layer. From about 0-80% by weight of the preferred first layer or other individual layer, more preferably about 5%, of one or more additives may be added. Preferred additives include neutralizers, process aids, lubricants, stabilizers, hydrocarbon resins, antistatics, antiblocking agents, fillers, ultraviolet stabilizers and other specialty additives suitable for use in specific applications.

The multi-layer sheet also includes a second layer 54 and a sixth layer 62 each comprising less than about 22.5% by volume of the multi-layer sheet and formed of a composition B composed of a regrind of recycled plastic such as from about 0.5-100% by weight, more preferably from about 50-99% by weight, more preferably from about 70-99% by weight, and most preferably from about 90-99%, of at least one polyolefin polymer. Preferred polyolefin polymers include polyethylene, polypropylene, polybutenes, polyisoprene, copolymers thereof, terpolymers thereof, and mixtures thereof. Particularly preferred is high density polyethylene (HDPE). Composition B may also include ethylene vinyl alcohol copolymer resins (EVOH) having a particle size less than 20 microns and not exceeding about 8% by volume of composition B.

The multi-layer sheet also includes a third layer 56 and a fifth layer 60 comprising from about 0.75-3.5% by volume [change claims] of the multi-layer sheet wherein third layer 56 is formed of a composition C preferably composed of from about 0.5-100% by weight, more preferably from about 50-99% by weight, more preferably from about 70-99% by weight, and most preferably from about 90-99% of adhesive resins. A particularly preferred adhesive resin is a maleated linear low density polyethylene (LLDPE) which is primarily composed of maleic anhydride modified polyolefin with some residual maleic anhydride and may also contain small amounts of stabilizers, additives and pigments.

The multi-layer sheet also includes a fourth layer 58 comprising from about 2.0-50% by volume and, more preferably about 3% by volume, of the multi-layer sheet wherein fourth layer 58 is formed of a composition D which is preferably composed of from about 0.5-100% by weight, more preferably from about 50-99% by weight, more preferably from about 70-99% by weight, and most preferably from about 90-99%, of ethylene vinyl alcohol copolymer and, more preferably, 32 mol % ethylene vinyl alcohol copolymer. Fourth layer 58 provides a hydrocarbon barrier for reduction the emission of hydrocarbons permeating through the thermoplastic sheet. It will be appreciated by those skilled in the art that other embodiments, different compositions, arrangements and quantities of layers may be used to form the thermoplastic sheet of the present invention.

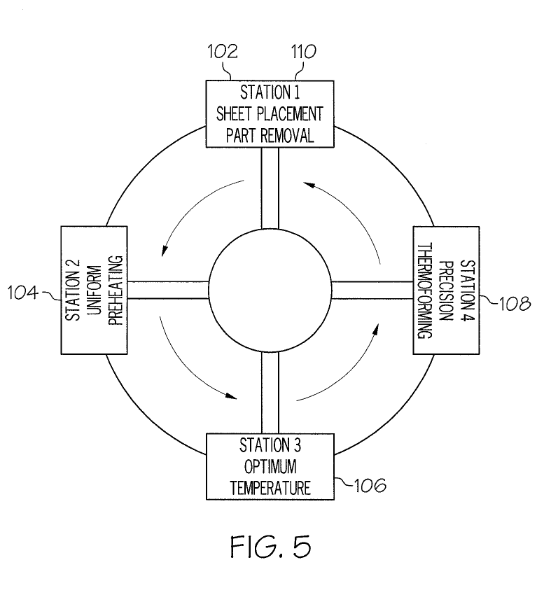

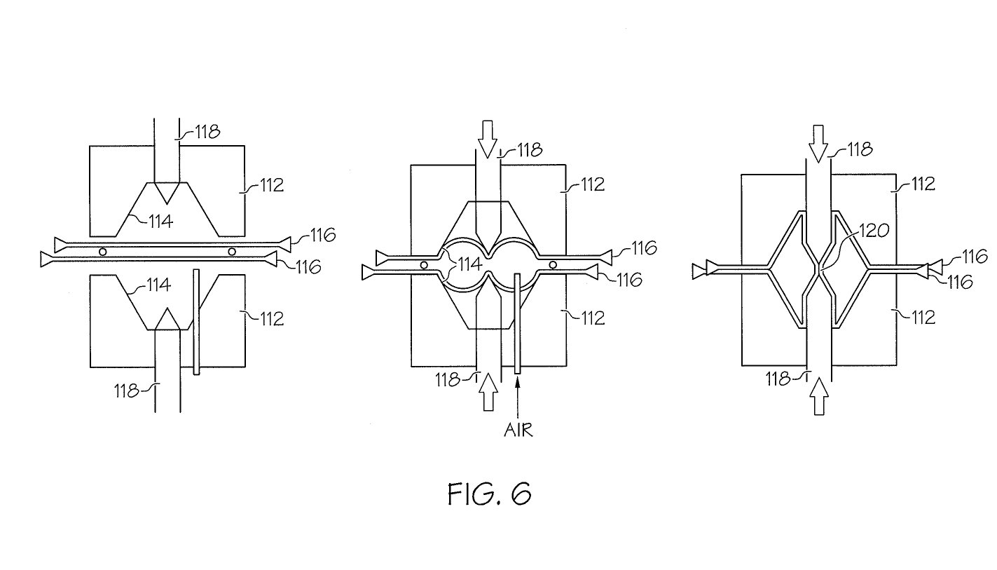

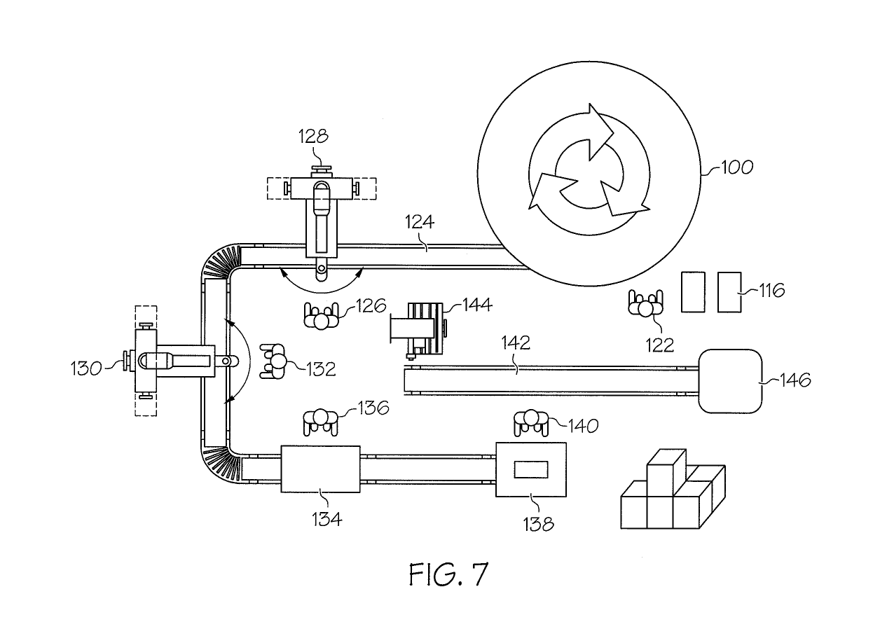

Turning now to FIGS. 5-7, a method of making fuel tank 10 or other twin sheet thermoformed article is described in detail herebelow. FIG. 7 illustrates a schematic diagram of one embodiment of a twin sheet parallel processing system 100. The twin sheet parallel processing system 100 includes a sheet placement stage 102, a preheating stage 104, an optimum temperature heating stage 16, a precision thermoforming stage 108, and a part removal stage 110 operatively cooperating as illustrated. The illustrated stages of twin sheet parallel processing system 100 is illustrative of the functional aspects of the system; however, one skilled in the art will appreciate that more or less stages may be used to identify the functional aspects in other embodiments. Twin sheet parallel processing system 100 is capable of high volume and efficient production of plastic containers such as fuel tank 10.

The plastic containers are preferably formed from thermoplastic sheets. As used herein, the term thermoplastic sheet refers to synthetic resins formed to have two relatively flat opposing surfaces. The thickness of the synthetic resin between the opposing surfaces is thin in comparison to the length and/or the width of the opposing surfaces. Thermoplastic sheets may be formed by monolayer, coextrusion or composite laminate techniques. Accordingly, each thermoplastic sheet may be formed of a single layer of synthetic resin or may include a plurality of layers. Exact specifications and characteristics of the thermoplastic sheets are provided by safety and performance standards associated with the particular article to be produced, e.g., plastic fuel tanks, including burst resistance, impact resistance and burn through resistance.

Referring again to FIG. 7, the sheet placement stage 102 is a loading point for a plurality of thermoplastic sheets 116. As used herein, the term “plurality of thermoplastic sheets” or “thermoplastic sheets” is defined to be any quantity of individual thermoplastic sheets up to an infinite number of thermoplastic sheets. In one embodiment, sheet placement stage 102 receives the thermoplastic sheets 116 and includes an automated mechanism to shuttle the thermoplastic sheets 116 to preheating stage 104. The thermoplastic sheets 116 may be received in the form of bundles, pallets, reams or directly from the extrusion process forming the thermoplastic sheets 116. Alternatively, a first operator 122 may physically load the thermoplastic sheets 116.

Preheating stage 104 may be any mechanism or device capable of raising the temperature of a plurality of thermoplastic sheets to a first temperature that is a pre-processing temperature. In one embodiment, the thermoplastic sheets are pre-conditioned in a convection oven. The convection oven provides blowing heat to heat-soak the thermoplastic sheets and raise the temperature of each of the sheets slowly and uniformly. In this embodiment, preheating stage 104 is a progressive multi-stage heat soak oven operating to provide continuous throughput. The progressive multi-stage heat soak oven increases the temperature of thermoplastics sheets placed therein. In addition, the oven provides for continuous insertion of additional thermoplastic sheets and removal of thermoplastic sheets progressively heated to the pre-processing temperature. In other embodiments, other heating mechanisms and techniques may be utilized to provide a continuous heating process such that some of the thermoplastic sheets within preheating stage 104 are at the pre-processing temperature while other thermoplastic sheets are being progressively heated. The preheating temperature may be any temperature less than the melt temperature of the thermoplastic sheets. Preferably, the preheating temperature is the maximum temperature at which the thermoplastic sheets may be handled and manipulated without damage. In one embodiment, the preheating temperature is between about 88-110° C.

Optimal temperature heating stage 106 may be any mechanism or device capable of rapidly raising the temperature of a group of thermoplastic sheets to a second temperature that is a processing temperature. In one embodiment, where the thermoplastic sheets are multi-layered, the final heater stage elevates the temperature to ensure that temperature sensitive material properties of all layers, such as, for example, viscosity are repeatably elevated to the processing temperature. Exemplary heating stages 106 include one or more banks of infrared heaters controlled as previously described. The heating temperature is an optimal temperature for subsequent processing within the thermoforming stage 108. The heating temperature places the group of thermoplastic sheets in a malleable condition that is preferably a molten state. In one embodiment, the heating temperature is in a range between about 199-216° C. In other embodiments, the heating may be higher or lower. In still other embodiments, the heating temperature of individual thermoplastic sheets within the group may be controlled to different temperatures to optimize subsequent processing in thermoforming stage 108.

Thermoforming stage 108 may be any mechanism or device capable of forming the group of thermoplastic sheets into portions of the low permeation fuel tanks or other plastic containers. Thermoforming stage 108 includes the capability to shape the group of thermoplastic sheets as well as capability to insert objects and join the group to form a container. Additional capabilities in other embodiments may include, for example, chemical treatment of the thermoplastic sheets, quality control, localized heating and/or cooling, material reallocation, appliqué and/or coatings. In addition, laminate applications and any other functionality pertaining to formation of fuel tanks or other containers may be included.

In one embodiment, thermoforming stage 108 uses the group of thermoplastic sheets and a mold to vacuum-form portions of fuel tank 10 as shown in FIG. 5. The mold may be two or more mold pieces 112 with a surface(s) 114 designed for contact with the group of thermoplastic sheets 116. The mold of one embodiment includes provisions for at least one mold insert. Mold inserts may be, for example, structural enhancements, externally mounted objects, objects penetrating one of the thermoplastic sheets in the group and/or any other objects desirous to form part of the plastic container. Thermoforming stage 108 may also include mold water heating and/or cooling, selective heating and/or cooling of portions of the mold, mechanical actuations or any other mold related functionality used in the thermoforming process.

Within thermoforming stage 108, mold pieces 112 are movable and may be separated to allow access to the surface(s) and facilitate insertion of objects. Objects, such as, for example, shuttle-in supports, foam internal cavities, structural components and/or connectors may be inserted and coupled with the group of thermoplastic sheets. Coupling with the group of thermoplastic sheets 116 may include embedding the object in at least one of the thermoplastic sheets within the group, welding, gluing and/or any other mechanism for fixedly positioning the object with respect to at least one of the group of thermoplastic sheets 116.

Following shaping and object insertion, mold pieces 112 are aligned and brought together. Mold pieces 112 are brought together under considerable compressive loading to fuse the group of thermoplastic sheets 116 and form a container. A plug assist 118 may be used to aid or assist stretching of thermoplastic sheets 116 prior to total contact with mold pieces 112. Plug assist devices are well-known devices that aid in manipulating the group of thermoplastic sheets to maintain minimum sheet thickness during the forming process. Plug assist devices are particularly effective in the described embodiments due to the almost unlimited access to the contact between the surface(s) of the bottom and top mold pieces 112 and the respective thermoplastic sheets 116. Effectiveness of the plug assist 118 is also enhanced by the ability to perform the plug assist operation on each of the bottom mold piece 112 and the top mold piece 112 simultaneously thereby minimizing processing time, heat loss and process variations.

Thermoplastic sheets 116 are fused to form a hermetic seal 120 commonly referred to as a pinch-off region. The resulting container is pressurized to fully conform the group of thermoplastic sheets 116 to the mold pieces 112, encapsulate objects/mold pieces and improve finish and definition. In one embodiment, the complete container is fuel tank 10. In other embodiments, other types of containers may be formed. Advantageously, a fuel tank or other plastic container produced in this manner is capable of providing sharp detail such that the container may be made with different textures, logos, shaper radii, and label recesses depending upon the particular application and specifications desired. Moreover, the top and bottom portions (e.g., first shell portion 22 and second shell portion 24) may have independent geometries allowing for different functional design features.

Part removal stage 110 may be any mechanism, person or device capable of receiving the plastic container from the thermoforming stage 18. Part removal stage 110 of one embodiment provides cooling and transferability of fuel tanks to other systems for final detailing and packaging. A lift table, slide table or grippers may receive the plastic container parts from clamp frames at part removal stage 110. The parts are placed on a first conveyor belt 124 and conveyed to an indexing station or table at robotic knife trimming stage 128 whereupon the container parts are indexed using vacuum gripper parts that are oriented for a trimming operation. Mechanical/vision indicators are used to recognize gripper location and a unique end of arm tooling may be used for individual plastic container designs.

A second operator 126 uses a robotic hot knife trimmer 128 to trim any excess material from the plastic container. The scrap or excess material is placed on a second conveyor belt 142 whereupon second operator 126 may manually cut the scrap at a horizontal band saw stage 144 or this process may be performed automatically. Second conveyor belt 142 drops the scrap material into a floor grinder 146. The plastic container then moves along conveyor belt 124 to a secondary boring, plate welding, and/or trimming 132 operated by a third operator 132 to bore vertical or horizontal holes and trim or miter ends of the plastic container according to specifications to determine location, angles, depth, diameter, and number of holes to bore and cuts to be made by saws. Third operator 132 positions the plastic container under clamps and against stops on machine bed, and depresses pedal or turns an automatic cycle lever to activate machine to clamp, bore, trim, and release the plastic container. A unique locating fixture may be provided at this stage for each tank design. Third operator 132 places the container on a locating fixture and secondary chipless boring, plate welding, and/or trimming is completed.

Next, the plastic container is removed from the locating fixture and continues to move along conveyor belt 124 to an assembly stage 134 operated by a fourth operator 134 wherein fourth operator 134 assembles individual parts of the plastic container and/or plugs various apertures or holes for testing. Finally, the plastic container moves along conveyor belt 124 to a testing stage 138 operated by a fifth operator 140 wherein the plastic container is tested for leaks. In one embodiment, a unique testing fixture for each individual tank design may be provided that incorporates different inlet or fill spout diameters and may also plug holes for testing. After testing, the plastic container is packed for final shipment.

Fuel tanks manufactured using the automated or combination automated/manual method described hereinabove were subjected to various tests to determine suitability for intended uses. In a first test, a multi-layer thermoformed snowmobile fuel tank was tested for durability when subjected to burn testing in accordance with ASTM D 635 Test Procedure. The results of this test are shown below in Table 1.

TABLE 1

| | Pre-Test Thickness of the | |
|---|---|---|
| Sample # | Sample (mm) | Burn Rate (mm/min) |
| 1 | 5.2 | 14 |
| 2 | 2.4 | 41 |
| 3 | 5.5 | 20 |
| 4 | 3.2 | 30 |
| 5 | 4.9 | 20 |
| 6 | 4.6 | 28 |
| 7 | 5.3 | 23 |
| 8 | 4.5 | 26 |
| 9 | 4.9 | 29 |
| 10 | 2.8 | 38 |
| Average | 4.33 | 25.9 |
| Standard Deviation | 1.11 | 8.27 |

In a second test, a multi-layer thermoformed snowmobile fuel tank was tested to determine the effect of a 30-day ambient temperature soak in EEE test fuel. In this test, the fuel tank vent hole was sealed, the tank was filled with lead-free EEE fuel, the tank was closed tightly and weighed to the nearest 28 g, the filled tank was stored for 30 days at 23° C.+/−3° C., and then re-weighed. The results of this test are shown below in Table 2.

TABLE 2

| | | | Tank | | Pre-Test | Post-Test | Tank Weight |
|---|---|---|---|---|---|---|---|
| | | | Capacity | Test Duration | Tank Weight | Tank Weight | Delta |
| TSG ID | Customer ID | Test Fluid | (gol) | (days) | (grams) | (grams) | (grams) |
| 04791-10 | N/A | EEE | 3.00 | 30.0 | 9613.2 | 9610.3 | −2.9 |

| | | |
|---|---|---|
| Date | 4/14/05 @ 3:15 PM | 5/13/05 @ 1:00 PM |
| Temperature (° C.) | 21.5 | 21.0 |
| Humidity (%) | 23.0 | 32.0 |
| Barometeric Pressure | 989.0 | 984.0 |
| (millbars) | 989.0 | 984.0 |

In a third test, a multi-layer thermoformed snowmobile fuel tank was tested to determine its durability when subjected to extreme cyclic temperatures for approximately 130 hours. In this test, the fuel tanks were filled with snowmobile fuel and allowed to remain at room temperature for approximately one week. The tanks were then emptied and tested as shown below in Table 3 and Chart 1.

TABLE 3

| Test Temperature Cycle(° C.) | Result |
|---|---|
| Hold for 5.5-hrs @ −40.0° ± 3.0°; | Completed 10.0-thermal cycles. No |
| Ramp to 60.0° ± 3.0 over 1.0-hr; | anomalies irregularities observed during |
| Hold for 5.5-hrs @ 60.0° ± 3.0; | the post-test visual inspection. |
| Ramp down to −40.0° ± 3.0° over 1.0-hr | |
| Total Cycles = 10.0 | |
| Hold for 5.5-hrs @ −40.0° ± 3.0°; | Completed 10.0-thermal cycles. No |
| Ramp to 60.0° ± 3.0 over 1.0-hr; | anomalies irregularities observed during |
| Hold for 5.5-hrs @ 60.0° ± 3.0; | the post-test visual inspection. |
| Ramp down to −40.0° ± 3.0° over 1.0-hr | |
| Total Cycles = 10.0 | |
| Hold for 5.5-hrs @ −40.0° ± 3.0°; | Completed 10.0-thermal cycles. No |
| Ramp to 60.0° ± 3.0 over 1.0-hr; | anomalies or irregularities observed during |
| Hold for 5.5-hrs @ 60.0° ± 3.0; | the post-test visual inspection. |
| Ramp down to −40.0° ± 3.0° over 1.0-hr | |
| Total Cycles = 10.0 | |
| Hold for 5.5-hrs @ −40.0° ± 3.0°; | Completed 10.0-thermal cycles. No |
| Ramp to 60.0° ± 3.0 over 1.0-hr; | anomalies or irregularities observed during the |
| Hold for 5.5-hrs @ 60.0° ± 3.0; | post-test visual inspection. |
| Ramp down to −40.0° ± 3.0° over 1.0-hr | |
| Total Cycles = 10.0 | |

In a fourth test, a multi-layer thermoformed snowmobile fuel tank was tested for durability when subjected to extreme temperatures. The results of this test are shown below in Table 4.

TABLE 4

| Sample Thickness | | Vicat Softening |
|---|---|---|
| (inches) | Sample Size (mm) | Temperature (° C.) |
| 0.148 | ≧10 × 10 | 129.9 |
| 0.130 | ≧10 × 10 | 129.7 |
| | Average | 129.8 |

In a fifth test, a multi-layer thermoformed snowmobile fuel tank was tested for impact resistance when subjected to impact testing at various extreme temperatures. The results of this test are shown below in Table 5.

TABLE 5
Pre-Conditioning Soak:

| TSG ID | Customer ID | Test Date | Test Fluid | Test Duration | Test Temperature | Result |
|---|---|---|---|---|---|---|
| 04791-04 | 6 | Apr. 22, 2005–Apr. 30, 2005 | Reference Fuel C | 168.0-hours | Laboratory | Completed one-(1) week |
| | | | | | Ambient | conditioning soak in |
| | | | | | | reference Fuel C. |
| 04791-05 | 7 | Apr. 22, 2005–Apr. 30, 2005 | Reference Fuel C | 168.0-hours | Laboratory | Completed one-(1) week |
| | | | | | Ambient | conditioning soak in |
| | | | | | | reference Fuel C. |
| 04791-06 | 8 | Apr. 22, 2005–Apr. 30, 2005 | Reference Fuel C | 168.0-hours | Laboratory | Completed one-(1) week |
| | | | | | Ambient | conditioning soak in |
| | | | | | | reference Fuel C. |

−40.0° C. Impact Testing:

| | | | | Test Temperature | | |
|---|---|---|---|---|---|---|
| TSG ID | Customer ID | Test Date | Test Fluid | (° C.) | Drop Height (meters) | Result |
| 04791-04 | 6 | May 2, 2005 | 50/50 Glycol- | −40.0 ± 3.0 | 1.25 | No leaks or cracks observed during |
| | | | Water Mixture | | | the post-test visual inspection. |
| 04791-05 | 7 | May 2, 2005 | 50/50 Glycol- | −40.0 ± 3.0 | 1.25 | No leaks or cracks observed during |
| | | | Water Mixture | | | the post-test visual inspection. |
| 04791-06 | 8 | May 2, 2005 | 50/50 Glycol- | −40.0 ± 3.0 | 1.25 | No leaks or cracks observed during |
| | | | Water Mixture | | | the post-test visual inspection. |

+60.0° C. Impact Testing:

| | | | | Test Temperature | | |
|---|---|---|---|---|---|---|
| TSG ID | Customer ID | Test Date | Test Fluid | (° C.) | Drop Height (meters) | Result |
| 04791-04 | 6 | May 3, 2005 | 50/50 Glycol- | +60.0 ± 3.0 | 1.25 | No leaks or cracks observed during |
| | | | Water Mixture | | | the post-test visual inspection. |
| 04791-05 | 7 | May 3, 2005 | 50/50 Glycol- | +60.0 ± 3.0 | 1.25 | No leaks or cracks observed during |
| | | | Water Mixture | | | the post-test visual inspection. |
| 04791-06 | 8 | May 3, 2005 | 50/50 Glycol- | +60.0 ± 3.0 | 1.25 | No leaks or cracks observed during |
| | | | Water Mixture | | | the post-test visual inspection. |

Post-Test Leak Check Testing:

| | | | | Tank Pressure | Immersion Fluid/ | |
|---|---|---|---|---|---|---|
| TSG ID | Customer ID | Test Date | Test Medium | (kPa) | Duration | Result |
| 04791-04 | 6 | May 10, 2005 | Laboratory Air | 35.0 | Water/30.0- | No evidence of leakage. |
| | | | | | seconds | |
| 04791-05 | 7 | May 10, 2005 | Laboratory Air | 35.0 | Water/30.0- | No evidence of leakage. |
| | | | | | seconds | |
| 04791-06 | 8 | May 10, 2005 | Laboratory Air | 35.0 | Water/30.0- | No evidence of leakage. |
| | | | | | seconds | |

From the foregoing, it may be seen that the inventive fuel tank and method of making the same is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. A fuel tank comprising:
a first shell formed from a thermoformed multi-layer sheet, said first shell including a first edge defining a perimeter of said first shell; and
a second shell formed from a thermoformed multi-layer sheet, said second shell including a second edge defining a perimeter of said second shell;
wherein said first and second edges form a seam;
wherein said first and second shells define a generally hollow interior; and
wherein each of said multi-layer sheets independently comprise:
at least one first layer composed of from about 0.5-100% by weight of at least one polyolefin polymer;
at least one second layer composed of from about 0.5-100% by weight of at least one polyolefin polymer;
at least one third layer composed of from about 0.5-100% by weight of at least one adhesive resin; and
at least one fourth layer composed of from about 0.5-100% by weight of an ethylene vinyl alcohol copolymer.

2. The fuel tank of claim 1, said first layer comprising from about 10-25% by volume of said multi-layer sheet.

3. The fuel tank of claim 1, wherein said first layer polyolefin polymer is selected from the group consisting of polyethylene, polypropylene, polybutene, polyisoprene, copolymers thereof, terpolymers thereof, and mixtures thereof.

4. The fuel tank of claim 3, wherein said polyolefin polymer is high density polyethylene.

5. The fuel tank of claim 1, said first layer further comprising less than about 49% by weight of a colorant.

6. The fuel tank of claim 1, said second layer comprising less than about 22.5% by volume of said multi-layer sheet.

7. The fuel tank of claim 1, wherein said second layer polyolefin polymer is selected from the group consisting of polyethylene, polypropylene, polybutene, polyisoprene, copolymers thereof, terpolymers thereof, and mixtures thereof.

8. The fuel tank of claim 7, wherein said polyolefin polymer is high density polyethylene.

9. The fuel tank of claim 1, said second layer further comprising less than about 8% by volume of an ethylene vinyl alcohol copolymer resin.

10. The fuel tank of claim 1, said third layer comprising from about 0.75-1.5% by volume of said multi-layer sheet.

11. The fuel tank of claim 1, said adhesive resin being a maleated linear low density polyethylene.

12. The fuel tank of claim 1, said fourth layer comprising from about 2.0-50% by volume of said multi-layer sheet.

13. The fuel tank of claim 1, said fourth layer comprising ethylene vinyl alcohol copolymer.

14. The fuel tank of claim 1, wherein any of said layer further comprises from about 0-80% by weight of an additive selected from the group consisting of neutralizers, process aids, lubricants, stabilizers, hydrocarbon resins, antistatics, antiblocking agents, fillers, ultraviolet stabilizers, specialty additives and mixtures thereof.

15. A method for making a fuel tank comprising:
thermoforming at least one thermoplastic sheet to form a molded body;
indexing said molded body;
trimming excess material from said molded body;
boring, welding, and/or trimming said mold body according to desired specifications;
assembling said molded body; and
testing said molded body.

16. The method of claim 15, said thermoforming step comprising:
preheating at least one thermoplastic sheet to a preheating temperature less than the melt temperature of said thermoplastic sheet;
heating said thermoplastic sheet to a processing temperature until said thermoplastic sheet is malleable;
molding said thermoplastic sheet to form a molded body;
sealing individual parts of said molded body; and
pressurizing said molded body.

17. The method of claim 15, further comprising the steps of:
conveying said molded body to an indexing and trimming station;
conveying said excess material to a floor grinder;
conveying said molded body to a secondary trimming station;
conveying said molded body to an assembly station; and
conveying said molded body to a testing station.

18. The method of claim 15 wherein said method is automated.

19. The method of claim 15 wherein said method is manual.

20. The method of claim 15 wherein said method is a combination of automated and manual.
